(19) United States
(12) Patent Application Publication
(10) Pub. No.: US 2006/0201445 A1
(43) Pub. Date: Sep. 14, 2006

(54) Toy for a horse to play with while standing in a stall

(76) Inventor: Janet L. Stonier, Laguna Woods, CA (US)

Correspondence Address: BUCHANAN, INGERSOLL & ROONEY PC, POST OFFICE BOX 1404, ALEXANDRIA, VA, 22313-1404, US

(21) Appl. No.: 11/076,098

(22) Filed: Mar. 9, 2005

(51) Int. Cl. A01K 29/00

(52) U.S. Cl. 119/707

(57) ABSTRACT

A toy for a horse formed from a hay-holding bag having a plurality of apertures passing therethrough, wherein the apertures are dimensioned such that small amounts of the hay protrude therethrough, but such that the horse can not remove all of the hay from the bag in less than 1 or 2 or 4 hours.

### TECHNICAL FIELD

The present invention is a toy for a horse. In various embodiments, the horse can play with the toy while standing in a stall, corral, pasture or next to and inside a trailer.

### BACKGROUND OF THE INVENTION

Horses are intelligent animals that welcome opportunities to play and stay occupied. Unfortunately, domestic horses typically spend a considerable amount of time just standing in their stalls. Horses are typically grazing animals by nature and would graze most of the time if given the opportunity. However, domestic horses are typically fed twice a day. After enjoying the feeding, there is little opportunity for the horses to amuse themselves while confined to a specific area. Horses can become bored and destructive to self and property when confined.

What is instead desired is a toy for a horse to play with while inside their stall, corral, horse trailer, and pasture. It would be desirable that such a toy provides one or more hours of amusement for the horse, with the toy keeping the horse's attention over this period of time. It would be optimal to satisfy a horse's natural desire to graze over longer periods of time. In the case of horses with feeding associated ailments (ie laminitis, colic, ulcers) it is desirable to regulate feed over longer periods of time.

### SUMMARY OF THE INVENTION

The present invention provides a toy for a horse to play with while standing in a stall, corral, horse trailer, or in a pasture. The present horse toy provides a system of slowly distributing hay to the horse, such that the horse must play with the toy for a one or more hours to remove all of the hay.

As such, entertainment is provided to the horse over the course of several hours. In addition, the horse does not lose interest in playing with the toy, as the horse is constantly rewarded for playing with the toy (by constantly receiving small amounts of hay). Also, by the horse playing with the toy filled with hay the horse is satisfying its natural grazing instincts. In the larger form, the toy can be used to feed the animal when the desired affect is to slow down the horses eating and simulate a natural grazing pattern thus occupying the horse's attention.

In a preferred embodiment, the present invention provides a toy for a horse, made from a bag having a plurality of apertures passing therethrough, the bag being dimensioned to hold hay therein, wherein the apertures are dimensioned such that small amounts of the hay protrude therethrough, but such that the horse can not remove all of the hay from the bag in less than 1 hour. In preferred embodiments, the toy requires at least 2 or 4 hours of play to release all of the hay therein.

In one particular embodiment, the present invention provides a toy for a horse, made from a bag formed from a plurality of cross straps connected together. The cross straps may be overlapping, and may optionally be arranged in a repeating over-under weave pattern; a layer pattern of horizontal and vertical straps; or a diagonal pattern of straps arranged in a layered fashion or an over-under weave pattern, wherein the overlapping cross straps are connected such that apertures are formed therebetween, and wherein the apertures have a maximum width of less than 6 inches. In some preferred embodiments, the apertures have a maximum width of less than 3 or just 2 inches.

The present invention is directed to a system that dispenses hay to a horse over a period of time (thus providing entertainment to the horse over that period of time). As a result, it is to be appreciated that various aperture dimensions and bag volume dimensions are contemplated within the scope of the present invention. For example, larger bags can accommodate larger apertures, whereas smaller bags will typically have smaller apertures (such that both relatively large aperture bags and relatively small aperture bags may both distribute the hay to the horse in relatively the same period of time).

### BRIEF DESCRIPTION OF THE DRAWINGS

FIG. 1 is a perspective view of the present toy in operation.

FIG. 2 is a front elevation view of a first embodiment of the present invention formed from a plurality of overlapping cross straps.

FIG. 3 is a front elevation view of a second embodiment of the present invention formed from a fabric bag with a plurality of apertures cut therethrough.

FIG. 4 is an enlarged perspective view of a portion of the bag of FIG. 2 or 3, showing the repeating over-under weave pattern of the overlapping cross straps.

FIG. 5 is an alternate embodiment of the present invention wherein a fabric bag is provided with a plurality of small apertures therethrough.

### DETAILED DESCRIPTION OF THE DRAWINGS

The present invention provides a toy for a horse. Specifically, the present invention provides a system for distributing hay to a horse over a period of time, so as to amuse the horse.

In this regard, the present inventor has discovered a unique system that offers hay to a horse wherein a balance is struck such that: (1) the hay is provided slowly to the horse, so the horse can play with the toy for a long period of time; but wherein (2) the horse sees and smells the hay in the toy, to keep the horse motivated to play with the toy; and wherein (3) the hay is eventually all removable such that the horse does not become discouraged playing with the toy.

To achieve this, the present invention provides a bag with apertures dimensioned small enough such that hay protrudes therethrough, but is not quickly removable therethrough by the horse. In addition, the present invention preferably places the apertures close enough together that the horse views and smells a considerable amount of the hay in the bag.

In one preferred embodiment, the present invention comprises a bag formed by overlapping cross straps connected together. In one preferred embodiment, the apertures comprises roughly half of the surface area of the bag. This provides the horse ample opportunity to see and smell the hay in the bag. In such embodiments, the width of the apertures is the same as the width of the cross-straps. As will be shown, the cross straps (and apertures therebetween) are dimensioned small enough such that hay is not easily removable from the bag. Rather, the hay has to be pulled out a few strands at a time, providing the horse with an amusing distraction.

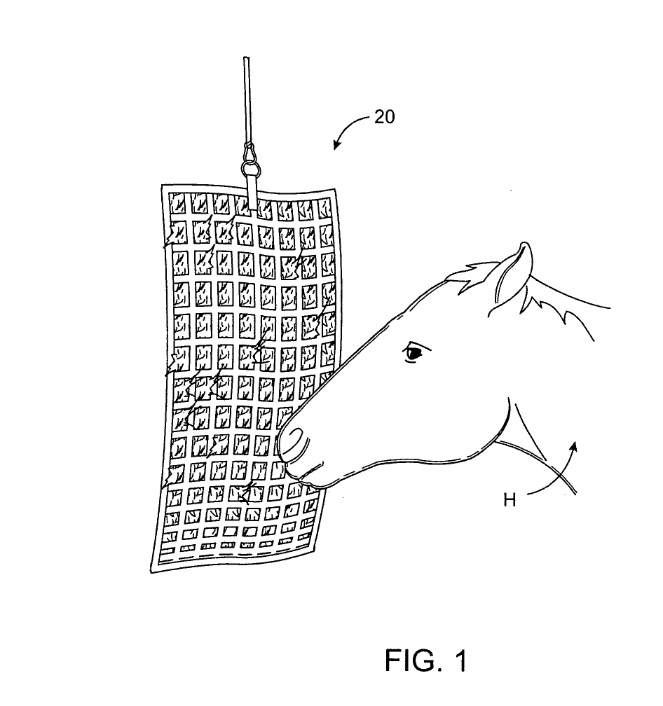

FIG. 1 shows an embodiment of the present invention in operation. A bag 20 is suspended in a horse's stall and filled with hay. The horse H pulls the hay out of bag 20 a few strands at a time. The top of the bag is openable such that a person can fill the bag with hay. In operation, the top of the bag is preferably secured to the wall, fence or other vertical flat surfaces of a stall, corral, horse trailer, or pasture such that the bag can be pushed against the flat surface by the horse when the horse plays with it.

As can be seen, an attachment mechanism, that may include a pair of rings 21 disposed on opposite sides of the top of the bag may be used to suspend bag 20 within a stable (or corral, or off the back of the horse trailer, etc.).

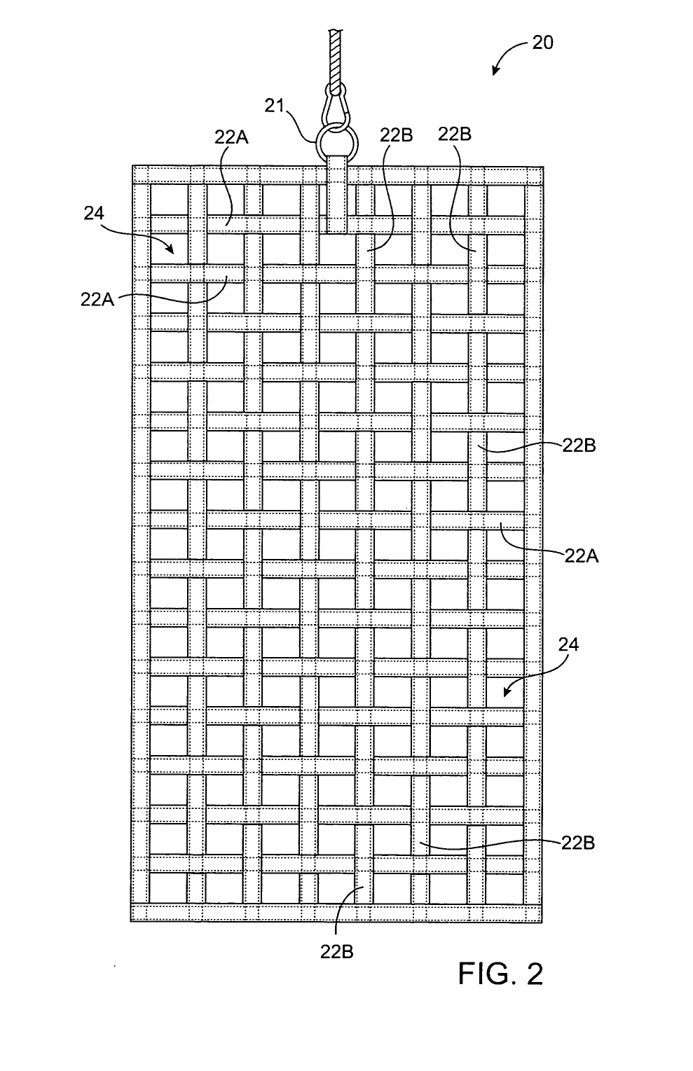

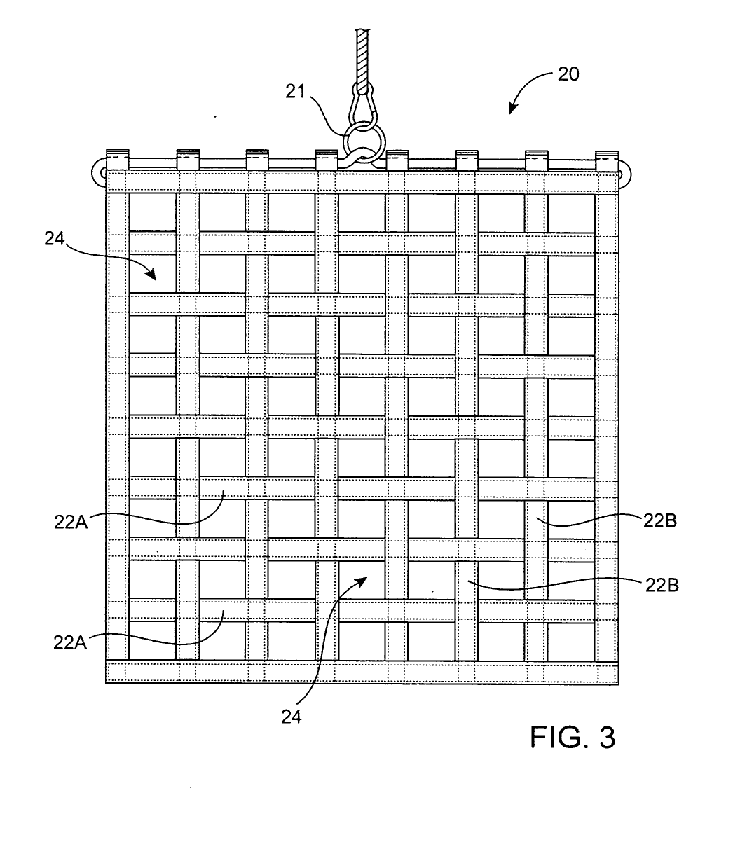

FIGS. 2 and 3 show preferred embodiments of the invention, as build by the inventor, as follows. Bag 20 is assembled from a plurality of overlapping cross straps 22 connected together so as to form apertures 24 therebetween. The difference between the embodiments of FIGS. 2 and 3 is in the overall dimensions of the bags, with the construction of the bags being the same.

Bag 20 in FIG. 2 has a width of 18 inches and a height of 27 inches. Cross straps 22 have a width of 1 inch and apertures 24 have a width of 1½ inches. Bag 20 in FIG. 3 has a width of 24 inches and a height of 28 inches. Cross straps 22 have a width of 1 inch and apertures 24 have a width of 2½ inches. It is to be understood that these dimensions are merely exemplary, and that the present invention is not limited to these particular dimensions or embodiments. The bag 20 in FIG. 3 has a larger volume than that of bag 20 in FIG. 2. In addition, the apertures 24 in FIG. 3 are wider than the apertures 24 in FIG. 2. As a result, the horse is able to more easily remove hay from the bag 20 in FIG. 3; however, there is more hay in the bag 20 (e.g.: one flake of hay) in FIG. 3. As a result, a horse may take the same amount of time to fully remove the hay from bags 20 in each of FIGS. 2 and 3. In the larger embodiment the horse takes enough hay to satisfy it's feeding requirement.

In accordance with the various embodiments of the present invention, apertures 24 preferably have a maximum width of less than 6 inches. In various embodiments, apertures 24 preferably have a maximum width of less than 3 inches. In various embodiments, apertures 24 preferably have a maximum width of less than 2 inches.

In accordance with the present invention, cross straps 22 may optionally have a width from ¼ to 3 inches, or more preferably from ½ inch to 2 inches. In preferred embodiments, the width of apertures 24 may correspond identically to the width of cross straps 22, as shown. It is to be understood, however, that the present invention is not so limited. For example, the width of apertures 24 may be less than the width of cross straps 22 (when cross straps 22 are placed closer together), or the width of apertures 24 may be more than the width of cross straps 22 (when cross straps 22 are placed farther apart).

As can be seen, overlapping cross straps 22 may preferably include a first series of parallel horizontal cross straps 22A; and a second series of parallel vertical cross straps 22B connected together to form rectangular apertures 24.

In preferred embodiments, bag 20 has a width of 10 to 50 inches, and a height of 20 to 70 inches. However, other dimensions are also contemplated within the scope of the present invention. For example, bag 20 may be made significantly wider so that two or more horses are able to play with it at the same time.

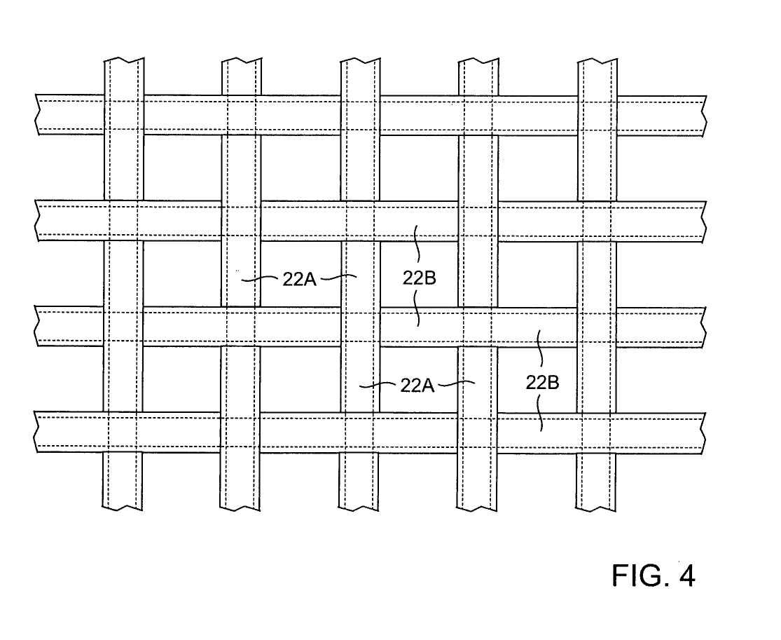

As can be seen in FIG. 4, the overlapping cross straps 22A and 22B can be arranged in a repeating pattern. For example, the overlapping cross straps may optionally be arranged in a repeating over-under weave pattern; a layer pattern of horizontal and vertical straps; straps arranged in a diagonal pattern in a layered fashion; or an over-under weave pattern with diagonal straps. Moreover, the respective cross straps 22A and 22B can be sewn (or glued) together at the locations where they overlap. In addition, the cross straps 22B at the sides and the cross straps 22A at the bottom of bag 20 may be reinforced by sewing/gluing them to corresponding straps on the opposite side of the bag.

In preferred embodiments, cross straps 22 are made of polypropylene, nylon or cotton. Cross straps 22 may be cut from poly, nylon or cotton webbing. The present inventor built the bags 20 in FIGS. 2 and 3 by cutting cross straps 22 with a hot knife from poly, nylon or cotton webbing having a tensile strength of 881 lbs. Hot glue is used to attach individual cross straps 22A to cross straps 22B. Such connections are all reinforced by being sewed together.

Preferably, apertures 24 are small enough such that the hay protrudes therethrough, but is not removable by a horse in less than 1 hour, or 2 hours, or even 4 hours.

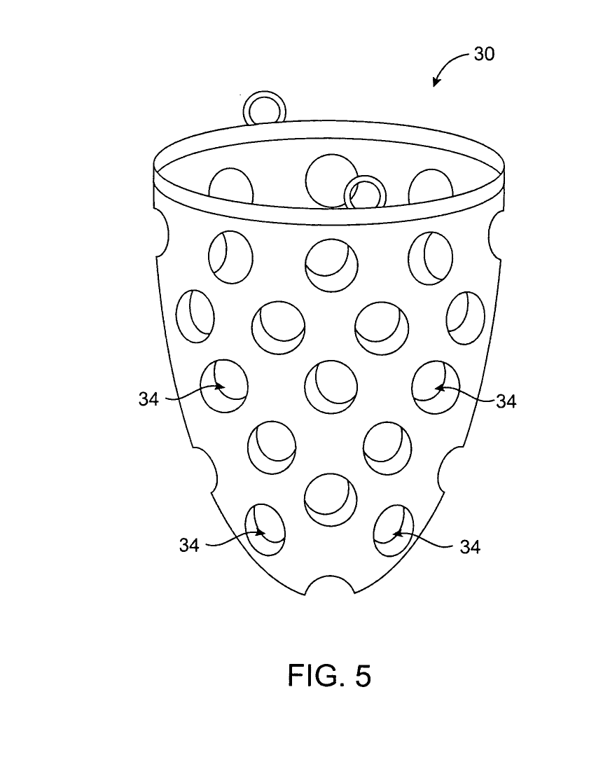

Another embodiment of the present invention is shown in FIG. 5, wherein a bag 30 is formed with apertures 34 passing therethrough. In this embodiment of the invention, no overlapping cross straps are used. Rather, bag 30 is formed form a fabric, that may include, but is not limited to, canvas or leather. Apertures 34 may be circular or square or any other shape, but preferably have a width of less than 6 inches, 3 inches, or 2 inches. Therefore, a horse can not typically remove all of the hay from the bag in less than 1, 2 or 4 hours.

What is claimed is:

1. A toy for a horse, comprising:
a bag formed from a plurality of overlapping cross straps connected together, wherein the overlapping cross straps are connected such that apertures are formed therebetween, and wherein the apertures have a maximum width of less than 6 inches.

2. The toy of claim 1, wherein the apertures have a maximum width of less than 3 inches.

3. The toy of claim 1, wherein the apertures have a maximum width of less than 2 inches.

4. The toy of claim 1, wherein the cross straps have a width from ¼ inch to 3 inches.

5. The toy of claim 4, wherein the cross straps have a width from ½ to 2 inches.

6. The toy of claim 1, wherein the overlapping cross straps comprises:
a first series of parallel cross straps; and
a second series of parallel cross straps.

7. The toy of claim 6, wherein the first series of parallel cross straps is positioned perpendicular to the second series of parallel cross straps.

8. The toy of claim 1, wherein the apertures are rectangular.

9. The toy of claim 1, wherein the cross straps are of the same width as the apertures.

10. The toy of claim 1, wherein the overlapping cross straps are arranged in a repeating over-under weave pattern.

11. The toy of claim 10, wherein the cross straps are sewn together at the locations where they overlap.

12. The toy of claim 10, wherein the cross straps are glued together at the locations where they overlap.

13. The toy of claim 1, wherein the cross straps at the sides and bottom of the bag are reinforced.

14. The toy of claim 1, wherein the bag has a width of 10 to 50 inches.

15. The toy of claim 1, wherein the bag has a height of 20 to 70 inches.

16. The toy of claim 1, further comprising:
an attachment mechanism at the top of the bag.

17. The toy of claim 16, wherein the attachment mechanism is a pair of rings disposed on opposite sides of the top of the bag.

18. The toy of claim 1, wherein the cross straps are made of polypropylene.

19. The toy of claim 1, wherein the bag is dimensioned to hold hay therein such that the hay protrudes through the apertures, but wherein the hay in the bag is not removable by a horse in less than 1 hour.

20. The toy of claim 19, wherein the hay in the bag is not removable by a horse in less than 2 hours.

21. The toy of claim 19, wherein the hay in the bag is not removable by a horse in less than 4 hours.

22. A toy for a horse, comprising:
a bag having a plurality of apertures passing therethrough, the bag being dimensioned to hold hay therein, wherein the apertures are dimensioned such that small amounts of the hay protrude therethrough, but such that the horse can not remove all of the hay from the bag in less than 1 hour.

23. The toy of claim 22, wherein the horse can not remove all of the hay from the bag in less than 2 hours.

24. The toy of claim 22, wherein the horse can not remove all of the hay from the bag in less than 4 hours.

25. The toy of claim 22, wherein the apertures have a maximum width of less than 6 inches.

26. The toy of claim 22, wherein the apertures have a maximum width of less than 3 inches.

27. The toy of claim 22, wherein the apertures have a maximum width of less than 2 inches.

28. The toy of claim 22, wherein the bag is formed from a plurality of overlapping cross straps connected together.

29. The toy of claim 22, wherein the bag is made of a fabric material.
